(19) United States
(12) Patent Application Publication
(10) Pub. No.: US 2008/0123871 A1
(43) Pub. Date: May 29, 2008

(54) Device for Generating Audio Signals

(76) Inventor: Alfred Trzmiel, Nurtingen (DE)

Correspondence Address: GUDRUN E. HUCKETT DRAUDT, SCHUBERTSTR. 15A, WUPPERTAL, 42289, omitted

(21) Appl. No.: 11/946,061

(22) Filed: Nov. 28, 2007

(30) Foreign Application Priority Data
Nov. 28, 2006 (DE) 10 2006 058 187.3
Jan. 12, 2007 (DE) 10 2007 003 201.5

(51) Int. Cl. H04B 1/00

(52) U.S. Cl. 381/86; 340/425.5

(57) ABSTRACT

An audio signal generating device to be mounted in a vehicle that operates noiseless or at a low noise level generates an audio signal that is audible for other traffic participants so that the risk of accidents is reduced. The audio signal generating device has at least one memory device for storing the at least one audio signal. The audio signal emitted by the audio signal generating device can be adjusted based on the engine speed or travel speed.

### BACKGROUND OF THE INVENTION

The invention relates to a device for generating audio signals.

Electrically operated vehicles as well as hybrid vehicles are known that, in addition to an electric motor, also have an internal combustion engine. The electric vehicles as well as the hybrid vehicles, when operated by means of the electric motor, have the advantage that they operate very quietly. However, this low noise level has the disadvantage that such vehicles are not audible or hardly audible for other traffic participants, for example, pedestrians, bicyclists etc. Therefore, there is a high accident risk for other traffic participants.

### SUMMARY OF THE INVENTION

It is an object of the present invention to configure the aforementioned vehicles in such a way that they can be reliably heard by other traffic participants.

In accordance with the present invention, this is achieved in that the device is mounted or installed in vehicles that operate without emitting noise or that operate at a very low noise level. The device according to the invention generates at least one audio signal that is audible for other traffic participants. For example, when a pedestrian wants to cross a street and does not pay attention to traffic, the pedestrian will be able to hear the vehicle operating at a low noise level or essentially noiseless when the aforementioned device for generating audio signals is used in the vehicle so that the pedestrian is warned of the approaching vehicle and the pedestrian will not be run over by the vehicle. The type of audio signal that is being emitted is not important. It is only important that the traffic participants will hear an audio signal emitted by the vehicle with the aid of the inventive device.

### BRIEF DESCRIPTION OF THE DRAWING

FIG. 1 is an end view of the device according to the invention for generating audio signals.

FIG. 2 is a side view of the device according to the present invention shown in FIG. 1.

### DESCRIPTION OF THE PREFERRED EMBODIMENTS

The device to be described in the following is an audio generator that serves for imparting a sound to a vehicle that operates without generating noise or operates at a very low noise level so that this vehicle can be heard by other traffic participants. In particular, in this way pedestrians are protected that want to cross the street and would otherwise not hear the noiseless or low-noise vehicle. The type of noise or sound that is generated by the audio generator can vary. It is only important that the sound or noise imparted to the vehicle can be reliably heard by the traffic participants. The traffic participants in question are not only pedestrians but also, for example, bicyclists, motorcyclists or other motorists. They are also made aware of the vehicle equipped with the audio generator so that the danger of an accident involving such a low-noise or noiseless vehicle is eliminated or at least significantly reduced.

Which type of sound is emitted by the audio generator is not important for traffic safety. It is only important that the traffic participants can hear a sound or noise and, in this way, are made aware of the vehicle. For example, the audio generator can produce the sound of a motor, for example, the sound of a Harley-Davidson for a scooter or the sound of a sports car for a hybrid vehicle that has an internal combustion engine as well as an electric motor. These are only examples of possible sounds to be generated by the audio generator. The audio generator is advantageously designed such that it can generate all kinds of sounds, inasmuch as they are permissible by law. The audio generator in the simplest case is designed such that it generates only a single sound. In a more advanced design, the audio generator is designed such that the user can select a sound from several sounds being offered.

The audio generator can be arranged in a housing and can be mounted on a printed circuit board provided in the vehicle or, for example, can be plugged into a free plug of a control unit in the motor compartment of the vehicle. The audio generator has at least one memory device on which the sound or noise is saved. This memory device can be a memory chip, a microchip or the like.

The audio generator has advantageously at least one interface. In this way, it is possible that the user of the audio generator can select a sound himself and optionally can select and download more sounds from the Internet.

The audio generator is a simple and inexpensive component that requires only minimal space. As a speaker for playing the sound, a piezo element is advantageously used. It can advantageously be arranged on the car body of the vehicle in such a way that the car body, upon movement of the piezo element, will be excited to perform vibrations. In this case, the car body is a speaker diaphragm. Of course, a conventional speaker can be used also for playing the saved sound.

The sound or the noise is advantageously generated and/or changed as a function of the vehicle speed. The motor speed signal can be taken from the CPU (central processing unit) of the vehicle or can be, for example, derived from the position of electronic accelerator pedal of the vehicle (electronic accelerator pedal signal).

The audio generator can also be provided as a kit for retrofitting so that electric vehicles and hybrid vehicles already on the market can be retrofitted with such an audio generator. Such a kit for retrofitting is advantageously not larger than a match box. This retrofitting kit can be mounted easily, is of a small size, has minimal weight, and can be easily plugged in or installed in other ways in the vehicle.

In the following, in an exemplary fashion one embodiment of an audio generator will be described. This embodiment is not to be understood as limiting the invention but is meant to illustrate one possible configuration.

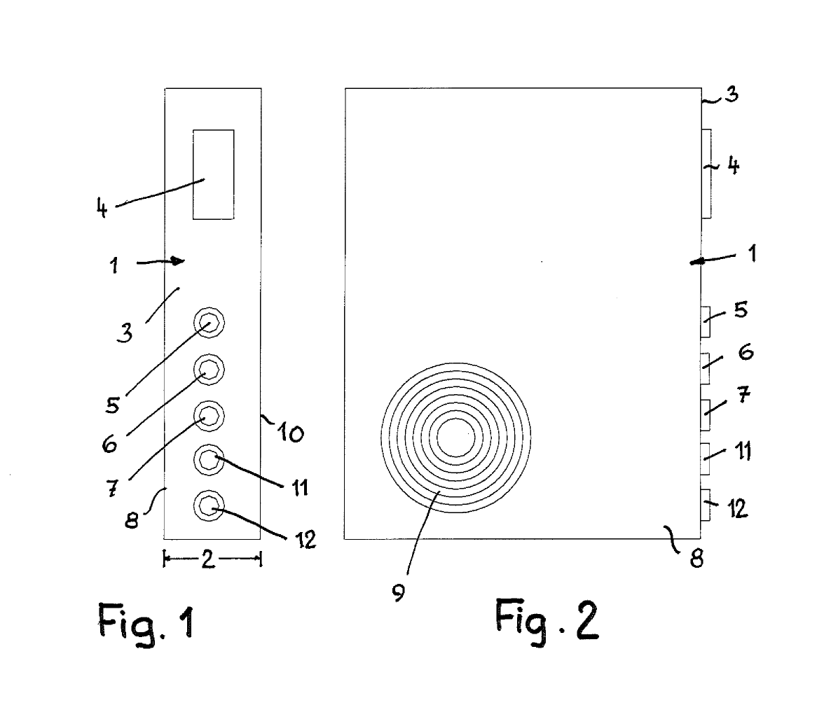

The audio generator according to FIGS. 1 and 2 has a housing 1 that is e.g. of a parallelepipedal configuration. It therefore has only a minimal width 2 so that the audio generator can be mounted without problems in the vehicle. When the vehicle is e.g. a small car, the housing can be placed e.g. into the glove box, underneath the driver's seat, or in the trunk. When the vehicle is e.g. a bicycle or a motor scooter, it can be mounted on the bicycle frame or on the handle bar of the bicycle or scooter. Of course, the housing 1 can also have any other shape. In particular, the configuration of the housing 1 can be matched to the mounting location, respectively.

The housing can be made from metal or can be made from a durable plastic material. The use of plastic material is preferred when the housing 1 is to be used on bicycles, motor scooters etc. where the housing 1 is exposed to the environment. When the device according to the invention is used within a motor vehicle, the housing can be made from a different material, in particular, an inexpensive material.

One sidewall of the housing 1, preferably its narrow end face 3, is provided with connectors and controls. There is a plug-in connector 4 for a transfer cable provided on the end face 3. The transfer cable can be connected to this connector 4 and the audio generator can thus be connected to a PC (personal computer) in order to download from the Internet sounds, noises etc. Advantageously, the connector 4 is a USB (universal serial bus) interface, preferably a USB-2 interface, or a firewire interface. This has the advantage that the connector 4 can also receive a USB stick on which noises, sounds, and the like are saved. In this case, the corresponding files can be transferred from the USB stick to the audio generator. This has the advantage that the user of the audio generator can download at home the desired audio files from the Internet and save them on the USB stick. The audio generator thus must not be removed from the vehicle and connected to the PC.

In the housing 1 there is at least one data storage means that can be in the form of a hard drive, a memory chip or a microchip, a flash memory or the like. The flash memory has the advantage that it is insensitive with regard to vibrations. Flash memories have sufficiently large capacities so that even large audio files can be saved thereon.

It is moreover possible to store the audio files on flash memory cards as they are known from still cameras or video cameras. The flash memory card can be removed from the housing 1 and, for example, inserted into a card reader of a home computer. It is then possible without a problem to download from the Internet the desired audio files and to save them on the flash memory card.

Below the connector 4 there is a speaker connector 5 to which an external speaker can be connected. This is advantageous when the audio generator is mounted within the vehicle and the noise or sound is to be transported to the exterior. In this way, a speaker located on the exterior of the motor vehicle can be connected to the speaker connector 5 so that the sound is not emitted within the vehicle but outside the vehicle by means of the external speaker. The housing 1 can be provided with additional speaker connectors so that more than one external speaker can be used.

On the end face 3 below the speaker connector 5, there is a signal connector 6 to which can be connected a switch for switching on and off the audio generator.

On the end face 3 below the signal connector 6, there is a connector 7 for an external volume control in order to individually adjust the volume of the speaker. The connector 7 is connected such that it controls the external speaker source that is connected to the speaker connector 5. Moreover, in the housing 1 at least one internal speaker can be provided that can be controlled also by means of the speaker control connected to the connector 7. Depending on the size of the housing 1, one or several internal speakers can be provided. In the sidewall 8 of the housing there is at least one speaker opening 9 through which the sound generated by the internal speaker can be emitted to the exterior. Depending on the number of internal speakers, additional speaker openings can be provided in the sidewall 8. Advantageously, on the opposite sidewall 10 of the housing 1 there is also at least one speaker opening.

On the end face 3 below the connector 7 for the volume control, there is a connector 11 for an engine speed signal transducer. Accordingly, through the connector 11 a motor speed signal is supplied to the device similar to the speedometer signal of a bicycle. In this way, the device can be controlled such that the internal and/or external speaker is switched on only at the point in time when the vehicle surpasses a certain speed. Also, by means of this connector the internal and/or external speaker can be switched off when the vehicle speed drops below a certain value. When no motor speed signal transducer is connected to the connector 11, the volume control is done by means of the volume control connected to connector 7.

Finally, on the end face 3 below the connector 11, there is a connector 12 for the current/voltage supply of the device. The device can be connected to a vehicle battery by means of the connector 12.

In principle, it is possible to operate the device by means of at least one battery. The battery is arranged so as to be easily removable behind a flap (not illustrated) in a sidewall of the housing 1. Instead of the battery, a rechargeable battery can be used; the rechargeable battery can be provided in addition to an external current/voltage supply. When the audio generator is operated by the vehicle battery, it is advantageous when the rechargeable battery arranged in the housing 1 is also charged at the same time. In this way, the audio generator can be operated without an external current/voltage source.

By means of the described audio generator, depending on its configuration, different effects can be achieved. For example, when accelerating or decelerating the vehicle, a change of the sound or a change of the sound level or volume can be generated. This is possible because by means of the connector 11 the audio generator is connected to the engine speed signal transducer. In this way, even when the vehicle is standing still or when the vehicle is driving at a constant or approximately constant speed, a special noise or sound can be generated. As desired, the user can save different types of sounds, noises, etc. in the memory device and recall them as needed when using the vehicle. The volume control can be changed manually and/or automatically as a function of the travel speed.

The sounds, noises, etc. can be downloaded as audio files, for example, from the Internet by means of a computer or by means of a mobile phone and then transferred to the memory in the housing 1. As an alternative or in addition, flash memory cards can be used onto which the desired audio files are recorded and which are inserted into an appropriate receiving slot provided in the housing 1. In this way, the audio files can be directly played from the flash memory cards.

The specification incorporates by reference the entire disclosure of German priority documents 10 2006 058 187.3 having a filing date of Nov. 28, 2006 and 10 2007 003 201.5 having a filing date of Jan. 12, 2007.

While specific embodiments of the invention have been shown and described in detail to illustrate the inventive principles, it will be understood that the invention may be embodied otherwise without departing from such principles.

What is claimed is:

1. A device for generating audio signals provided for mounting in a vehicle that operates noiseless or at a low noise level, wherein the device generates an audio signal that is audible for other traffic participants.

2. The device according to claim 1, comprising at least one memory for the at least one audio signal.

3. The device according to claim 2, wherein the at least one memory is a memory chip or a microchip.

4. The device according to claim 2, wherein the at least one memory is a hard drive.

5. The device according to claim 2, wherein the at least one memory is a flash memory card.

6. The device according to claim 2, comprising an interface for transferring the at least one audio signal to the at least one memory.

7. The device according to claim 6, wherein the interface is a USB interface or a firewire interface.

8. The device according to claim 1 configured as a plug-in part for a printed circuit board.

9. The device according to claim 1 adapted to be mounted on a printed circuit board of the vehicle.

10. The device according to claim 1, wherein the device receives a motor speed signal of the vehicle.

11. The device according to claim 10, wherein the motor speed signal is derived from a central processing unit of the vehicle.

12. The device according to claim 1, wherein the motor speed signal is derived from a position of an accelerator of the vehicle.

13. The device according to claim 1 comprising at least one piezo element as a speaker.

14. The device according to claim 13, wherein the piezo element is mounted on a car body of the vehicle such that the car body acts as speaker diaphragm.

15. The device according to claim 1, comprising a housing.

16. The device according to claim 15, wherein the housing has at least one connector for at least one external speaker.

17. The device according to claim 15, wherein the housing has at least one connector for an on/off switch.

18. The device according to claim 15, wherein the housing has at least one connector for a volume control.

19. The device according to claim 15, wherein the housing has at least one connector for a motor speed signal transducer.

20. The device according to claim 15, wherein the housing has at least one connector for a voltage/current supply.

21. The device according to claim 15, wherein the housing has at least one slot for a flash memory card.
